(19) United States
(12) Patent Application Publication
(10) Pub. No.: US 2026/0237315 A1
(43) Pub. Date: Aug. 13, 2026

(54) Parent-responsive Interactive Child Toy

(71) Applicant: Timothy M. Case, Mission Viejo, CA (US)

(72) Inventor: Timothy M. Case, Mission Viejo, CA (US)

(21) Appl. No.: 19/533,873

(22) Filed: Feb. 9, 2026

Related U.S. Application Data
(60) Provisional application No. 63/755,711, filed on Feb. 7, 2025.

(51) Int. Cl. G09B 5/02; A63H 33/22; A63H 3/00; A63H 11/00

(52) U.S. Cl. CPC G09B 5/02; A63H 33/22; A63H 3/003; A63H 11/00; A63H 2200/00

(57) ABSTRACT

Apparatus and related methods relate to indirectly parent-responsive interactive child displays. In an illustrative embodiment, an interactive toy may receive a responsive interaction index (RII) package from a separate device. The RII package may, for example, include an aggregated index derived from time-distributed parent-provided behavioral indicators regarding a child. At least some of the behavioral indicators may, for example, be provided when the child is not interacting with the toy. The interactive toy may, for example, display a dynamic indication in response to the child initiating interaction. A response generation engine may, for example, select the dynamic indication from predetermined indications based on the aggregated index. The dynamic indication may, for example, display a single present representation of the time-distributed behavioral indicators. Various embodiments may advantageously enable child-initiated automatic display of parental behavioral assessments in an engaging ongoing toy format.

### CROSS-REFERENCE TO RELATED APPLICATIONS

This application claims the benefit of US Provisional Application 63/755,711, titled "Parent- Responsive Interactive Child Toy," and filed Feb. 7, 2025 by Timothy Michael Case. The entire contents of the foregoing application are incorporated herein by reference. Unless expressly stated, changes in terminology from the prior application to this application are made without prejudice or disclaimer of subject matter. Changes from the prior application are intended to be broadening and/or additive unless expressly stated otherwise. Replacement of alternative terms with a single representative term, for example, are inclusive unless otherwise defined. Various embodiments may also be found in previous disclosure(s) incorporated by reference. Embodiments of similar languages in this application are not modifications or disclaimer of the embodiments disclosed in previous incorporated disclosures unless otherwise stated.

### BACKGROUND

Parents may, for example, play a crucial role in shaping their children's behavior and development through various forms of interaction and/or feedback. These interactions may, for example, include verbal praise, rewards, or constructive guidance when children exhibit positive behaviors. Parents may, for example, employ different strategies to encourage desired behaviors and/or discourage undesirable ones, which may help children develop important social skills, self- regulation abilities, and/or emotional intelligence.

Children may, for example, enjoy engaging with various types of interactive toys designed to provide entertainment and/or educational value. These toys may, for example, include electronic devices with lights and/or sounds, mechanical toys that respond to physical manipulation, and/or digital devices with interactive displays. Interactive toys may, for example, capture children's attention through multi-sensory engagement and/or dynamic responses to their actions.

Toys that children enjoy may, for example, include items such as building blocks, stuffed animals, and/or board games that encourage imaginative play and/or social interaction. These toys may, for example, be designed with features that stimulate multiple senses, such as visual elements, tactile textures, or audio components. Interactive elements may, for example, help maintain children's interest and/or create engaging play experiences that can support their development across various domains, including cognitive, social, and/or motor skills.

### TECHNICAL FIELD

Apparatus and methods generally relate to interactive devices.

### BRIEF SUMMARY

Apparatus and related methods relate to indirectly parent-responsive interactive child displays. In an illustrative embodiment, an interactive toy may receive a responsive interaction index (RII) package from a separate device. The RII package may, for example, include an aggregated index derived from time-distributed parent-provided behavioral indicators regarding a child. At least some of the behavioral indicators may, for example, be provided when the child is not interacting with the toy. The interactive toy may, for example, display a dynamic indication in response to the child initiating interaction. A response generation engine may, for example, select the dynamic indication from predetermined indications based on the aggregated index. The dynamic indication may, for example, display a single present representation of the time-distributed behavioral indicators. Various embodiments may advantageously enable child-initiated automatic display of parental behavioral assessments in an engaging ongoing toy format.

Apparatus and related methods generally relate to parent-responsive interactive display devices. In an illustrative example, a parent-responsive interactive display (PRID) receives responsive interaction index (RII) packages from a human machine interface (HMI) operated by a parent. For example, the HMI enables parents to input observations regarding child behavior. For example, the PRID generates responses to the child based on received RII packages. For example, the PRID may be configured as an LED array and/or snow globe device providing visual, audio, haptic, and/or other sensory feedback. For example, the PRID may include sensors configured to detect child interactions. The PRID may, for example, include actuators configured to generate responses to child interactions as a function of the RII. Various embodiments may, for example, advantageously enable dynamic child engagement through parent-influenced interactive responses configured to reinforce positive behaviors.

### BRIEF DESCRIPTION OF THE DRAWINGS

Various embodiments of the present embodiments are described with reference to the following FIGURES.

FIG. 1 depicts a parent-responsive interactive display (PRID) coupled to a human machine interface (HMI) in an illustrative use-case scenario automatically adjusting responses to child interaction in response to parent inputs.

FIG. 2A, FIG. 2B, and FIG. 2C depict block diagrams of illustrative implementations of the HMI and PRID.

FIG. 3 depicts an illustrative PRID system configuration method. FIG. 4 depicts an illustrative HMI operation method related to receiving and transmitting parent observations.

FIG. 5 depicts an illustrative PRID operation method. FIG. 6 depicts an illustrative block diagram depicting operation and/or training of an example response generation engine 225.

FIG. 7 depicts an illustrative embodiment of a child's toy including a PRID 130.

Like reference numerals refer to like parts throughout the various views unless otherwise specified. Embodiments and portions of embodiments illustrated and described herein are non- limiting and non-exhaustive.

### DETAILED DESCRIPTION

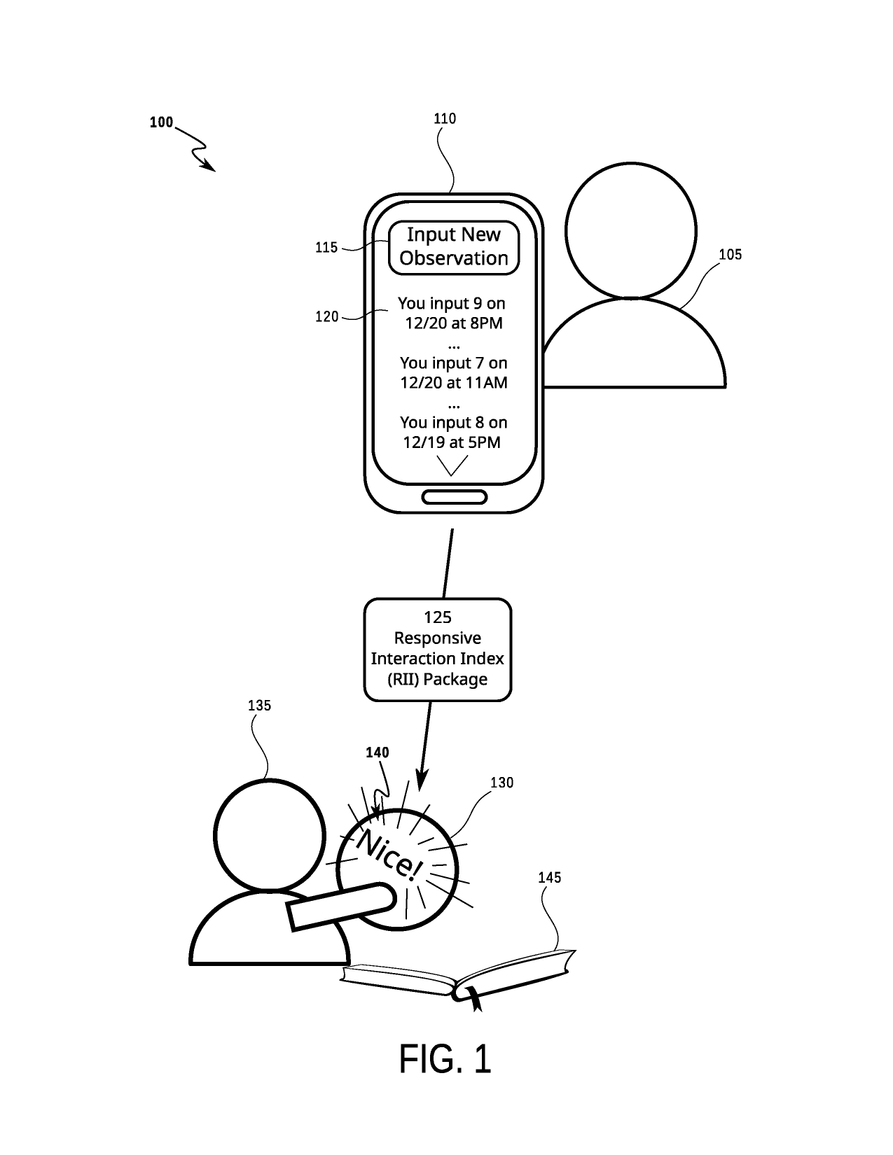

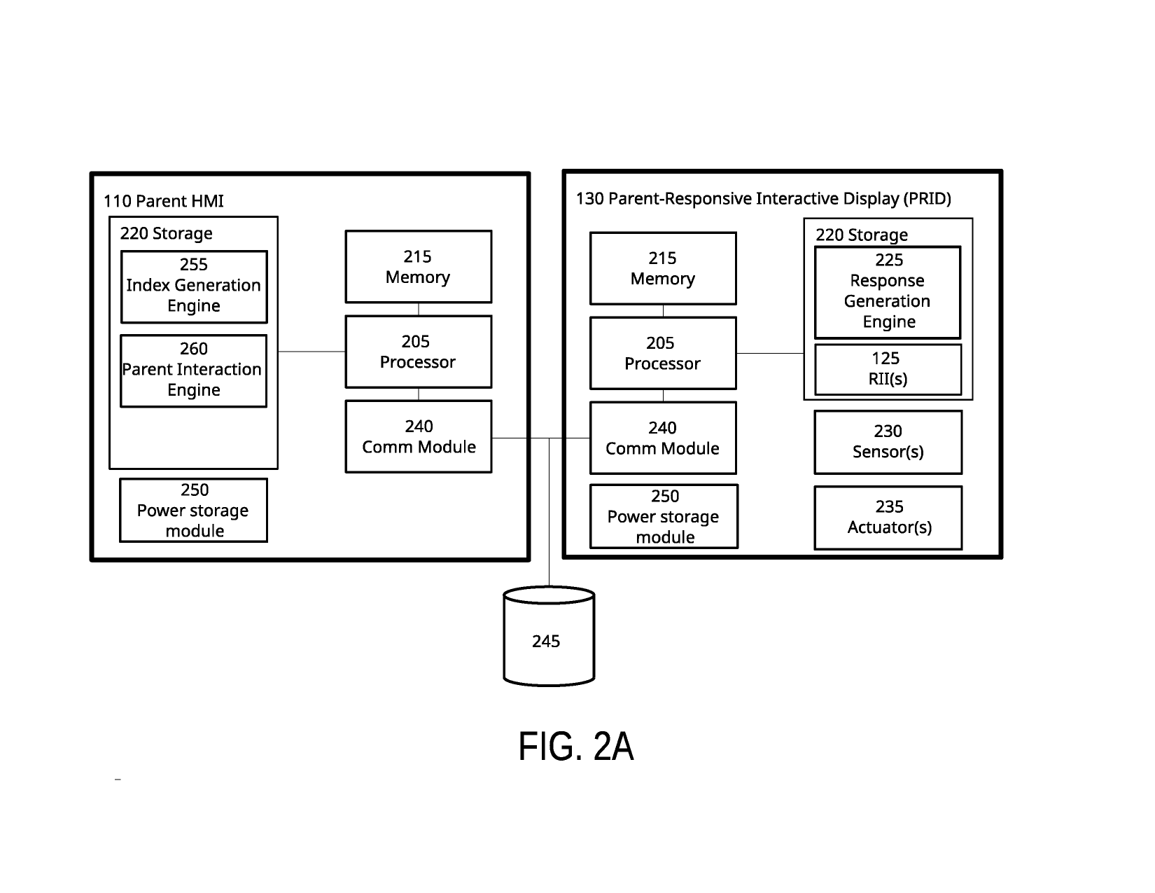

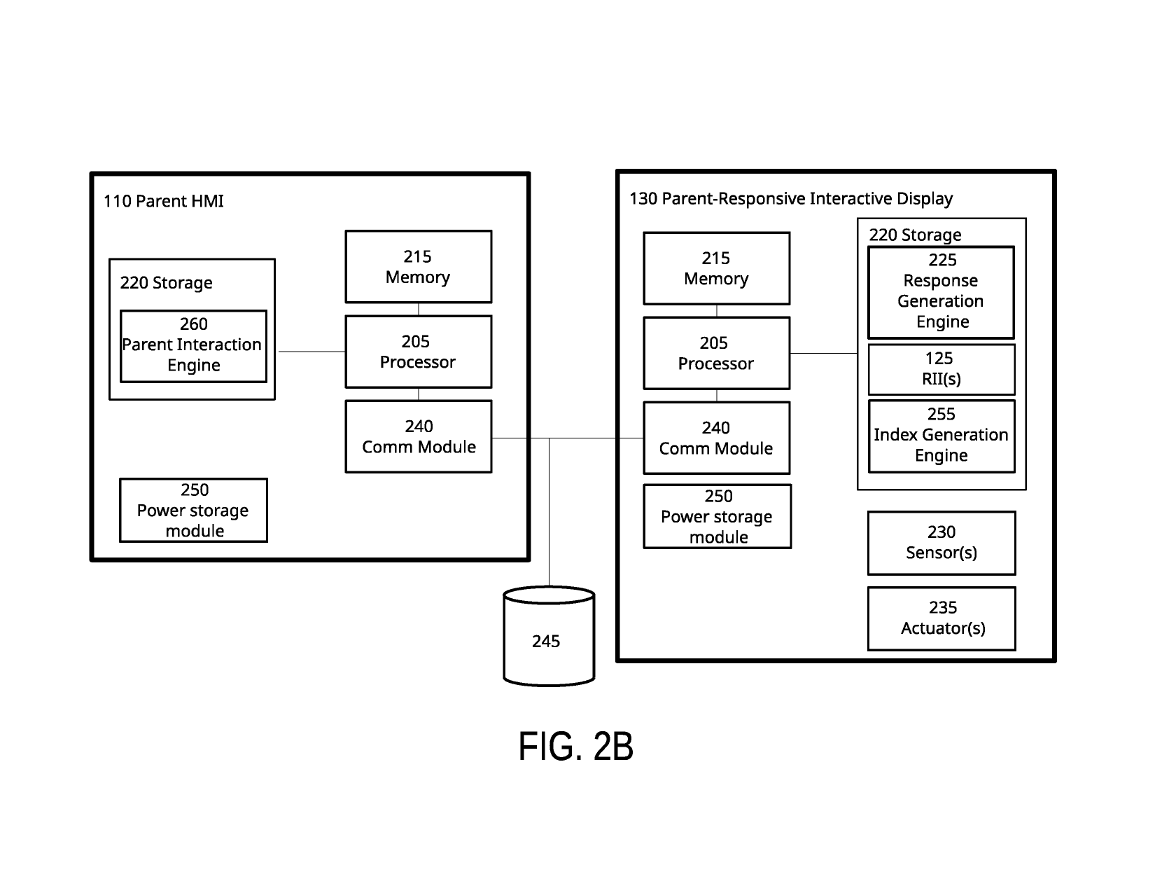

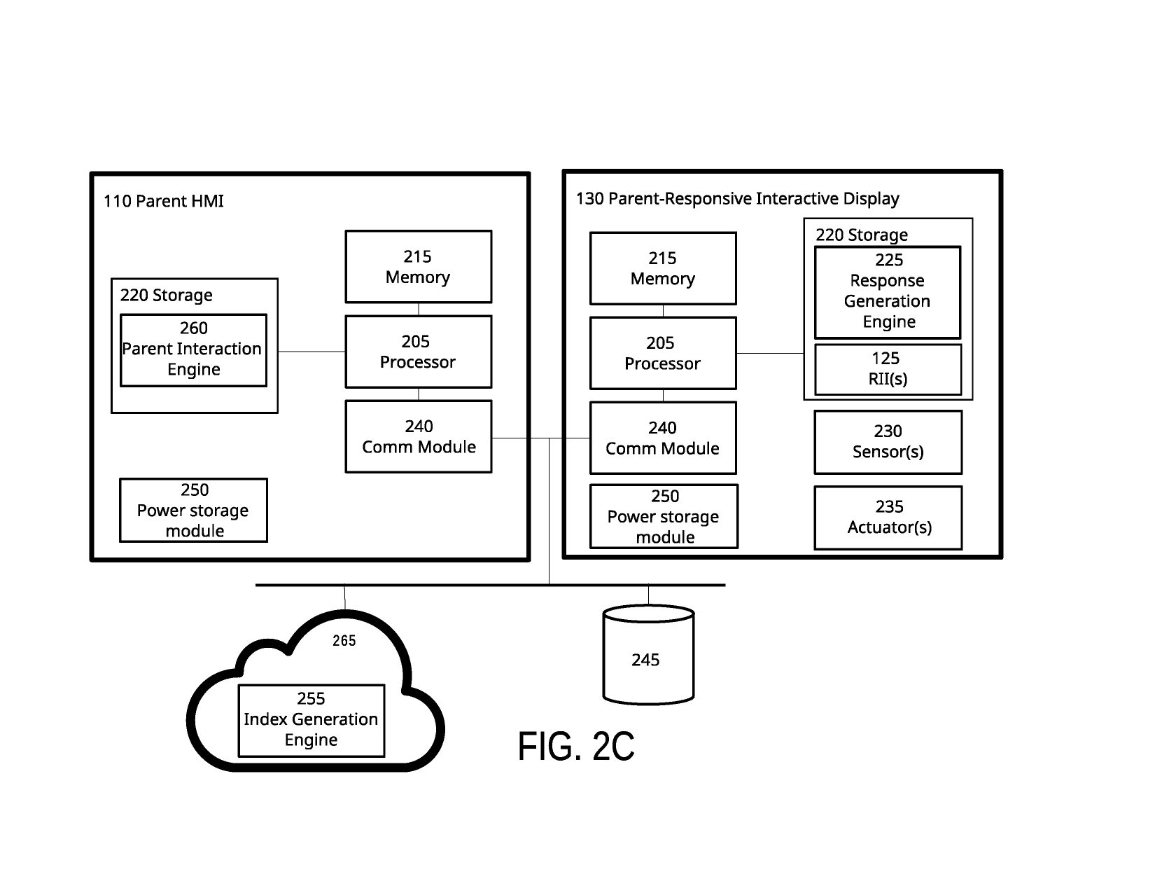

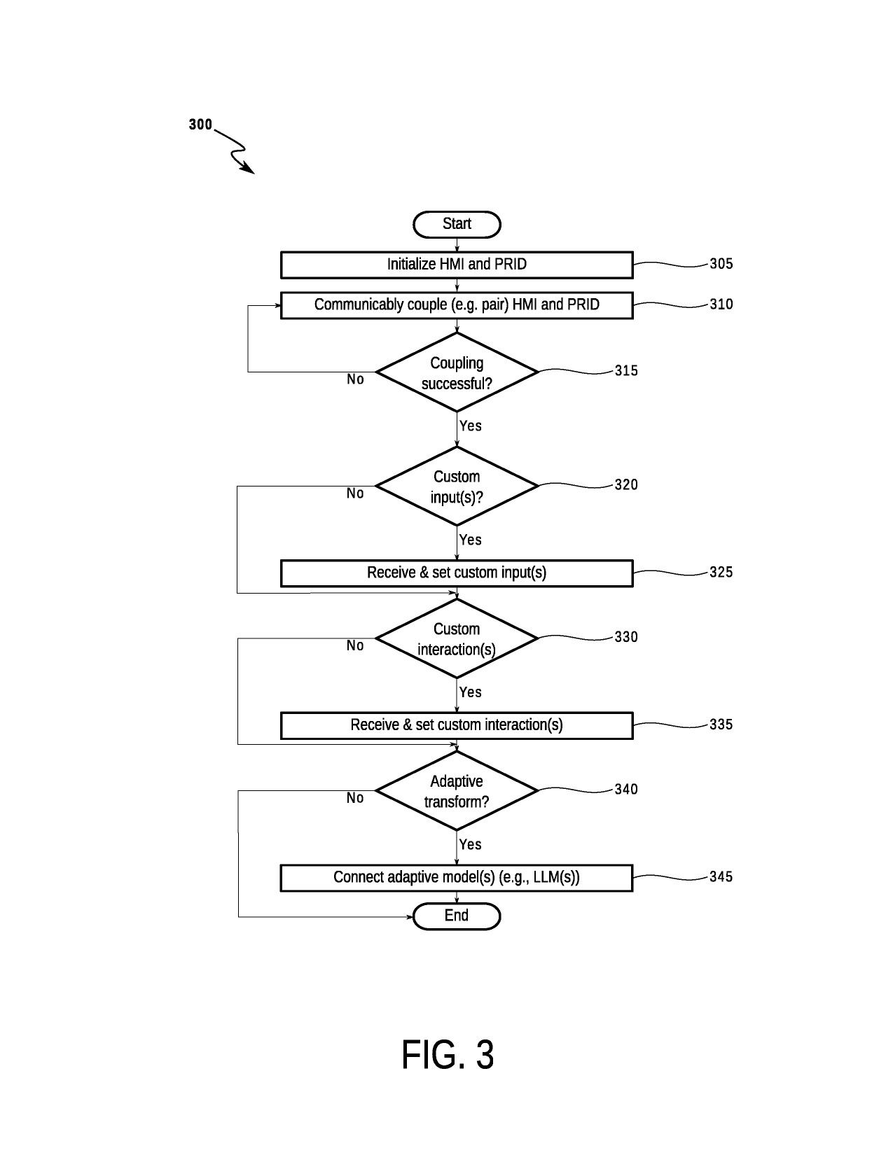

In order to assist rapid comprehension, this document introduces a parent-responsive interactive display (PRID) system in FIGS. 1-2C. Methods related to configuration and/or operation of a PRID and/or associated device(s) are described with respect to FIGS. 3-5. Then, an example child's toy incorporating a PRID is disclosed with respect to FIG. 6. Finally, various additional embodiments and/or features are discussed related to PRIDs.

FIG. 1 depicts an illustrative parent-responsive interactive system in operation in an illustrative use-case scenario 100. A parent 105 interacts with a human machine interface (HMI) 110 to provide input regarding observations of a child 135. The HMI 110 may, by way of example and not limitation, include a personal computing device (e.g., a smartphone, such as shown). The HMI 110 includes an interactive element 115 configured to receive and/or display prior inputs 120 from the parent 105. For example, as shown, the prior inputs 120 may include timestamped numerical ratings provided by the parent 105 regarding the child's behavior or other attributes. The HMI 110 generates a responsive interaction index (RII) package 125 based on the parent inputs, which is transmitted to a parent-responsive interactive display (PRID) 130. The PRID 130 generates and displays a response 140 to the child 135 based on the received RII package 125. In some embodiments, the response 140 may be coordinated with interaction between the child 135 and a book 145 and/or other interactive medium.

The PRID 130 may, in some examples, be configured as an LED array display device. For example, a spherical housing containing addressable LED matrices may display animated patterns and/or colors. An LED array configuration may, for example, advantageously enable dynamic visual feedback visible from multiple angles.

The PRID 130 may be configured, by way of example and not limitation, as a snow globe device. For example, a transparent sphere containing liquid and/or particles may be illuminated and/or agitated in response to interactions. A snow globe configuration may, for example, advantageously combine familiar physical interaction with enhanced digital features.

Parent inputs may, for example, include selection from predetermined scales. For example, parents may rate child behavior on a scale from 1-10 or select from preset categories like "Very Good," "Good," "Needs Improvement." Scale-based inputs may, for example, advantageously provide consistent, normalized data for generating responses.

Parent inputs 120 may, for example, include free-form text descriptions. For example, parents may enter detailed observations about specific behaviors or incidents. Free-form text input may advantageously capture nuanced context about behaviors.

Parent inputs 120 may, for example, include voice recordings. For example, parents may record audio notes about observations. The audio notes may, for example, be processed by language models, such as to extract sentiment and/or meaning, for example. Voice input may advantageously enable quick, natural documentation of observations.

FIG. 2A-2C depict block diagrams of illustrative implementations of the HMI 110 and PRID 130. As shown in FIG. 2A, the HMI 110 and PRID 130 each include a processor 205 operably coupled to memory 215 and storage 220. The processor 205 may include, for example, one or more processing units. The processor 205 may, for example, be configured to execute instructions (e.g., stored in memory 215 and/or storage 220).

The processor(s) 205 is operably coupled to memory 215. The memory 215 may, for example, include one or more physical modules. For example, the memory 215 may include random access memory. The memory 215 may be configured, by way of example and not limitation, to hold program(s) of instruction and/or operating data during and/or around execution by the processor(s) 205.

The processor(s) 205 is operably coupled to a storage module 220. The storage module(s) 220 may, for example, include multiple storage devices. For example, the storage module(s) 220 may include hard disk storage. The storage module(s) 220 may, for example, include solid state storage. The storage module(s) 220 may, for example, be configured to store one or more programs of instruction. A program of instruction may, for example, be configured to cause operations to be performed when executed by the processor(s) 205. For example, program(s) of instruction may be loaded (e.g., temporarily) from the storage module(s) 220 into the memory 215 such as, for example, in preparation for and/or during execution by the processor(s) 205.

As shown, in this example the storage module(s) 220 (e.g., of the HMI 1f0, such as shown in FIG. 2A) includes a parent interaction engine 260. The parent interaction engine 260 may be configured, for example, to receive and/or process parent inputs regarding child observations. For example, the parent interaction engine 260 may generate graphical user interfaces enabling parents to input behavioral observations, process touch/gesture inputs, validate input data, and/or coordinate with the index generation engine 255 to generate responsive interaction index (RII) packages. In some embodiments, the parent interaction engine 260 may receive numerical ratings from parents. For example, parents may rate child behavior on predetermined scales such as 1-10 or select from preset categories like "Very Good," "Good," or "Needs Improvement." Scale-based inputs may advantageously provide consistent, normalized data for generating RII packages.

The parent interaction engine 260 may receive free-form text descriptions. For example, parents may enter detailed observations about specific behaviors or incidents. The parent interaction engine 260 may process the text descriptions to extract relevant behavioral indicators. Free-form text input may advantageously capture nuanced context about behaviors.

In some implementations, the parent interaction engine 260 may receive voice recordings. For example, parents may record audio notes about observations which are processed by language models to extract sentiment and/or meaning. Voice input may advantageously enable quick, natural documentation of observations.

The parent interaction engine 260 may display prior inputs to parents. For example, as shown in FIG. 1, the parent interaction engine 260 may present timestamped numerical ratings and/or other historical observations. Displaying prior inputs may advantageously help parents track behavioral patterns over time.

In the depicted example, the parent interaction engine 260 coordinates with the index generation engine 255 to generate RII packages based on received parent inputs. The RII packages may include normalized behavioral indices derived from the parent observations. The RII packages are transmitted to the response generation engine 225, which generates appropriate responses to child interactions based on the behavioral indices.

The parent interaction engine 260 may, for example, validate input data before processing. For example, the engine may check that numerical ratings fall within valid ranges, verify text input meets length parameters, and/or ensure voice recordings have sufficient quality. Input validation may, for example, advantageously ensure reliable RII package generation.

In some embodiments, the parent interaction engine 260 may, for example, provide feedback to parents regarding their inputs. For example, the engine may display confirmation messages when inputs are received, show how inputs influence response generation, and/or alert parents if inputs may need modification. Parent feedback may, for example, advantageously help optimize the observation documentation process.

As shown, in this example the storage module(s) 220 (e.g., of the PRID 130, such as shown in FIG. 2A) includes a response generation engine 225. The response generation engine 225 may, for example, be configured to respond to child interactions, such as by generating appropriate responses based on the RII packages. For example, the response generation engine 225 may process sensor inputs and/or historical interaction data to determine appropriate responses.

The HMI 110 and PRID 130, in this example, each include a communication module 240. The communication module(s) 240 may, for example, include a wireless communication module. The wireless communication module may, for example, include a transmitter (e.g., radio) and/or receiver. The communication module(s) 240 may, for example, include a wired communication module (e.g., Ethernet port).

As depicted, the devices are operably coupled to a data store(s) 245. The data store(s) 245 may include, for example, a database. The data store(s) 245 may include, for example, a physical storage device. The data store(s) 245 may include, for example, a virtual storage network.

The data store(s) 245 may include, for example, a virtual storage network. The data store(s) 245 may, for example, store parameters. Parameters may, for example, include response templates, interaction thresholds, and/or behavioral metrics.

In some embodiments, the data store(s) 245 may include, for example, historical data. The data store(s) 245 may include, for example, historical parent inputs and/or child responses.

The data store(s) 245 may, for example, include associations between corresponding historical data. For example, associations may correlate corresponding parent inputs, responses, and/or outcomes. An association may, for example, be in the form of a matrix entry. An association may, for example, include a link attribute (e.g., identifier) to a corresponding data object. Historical data and/or corresponding associations may, for example, advantageously provide training and/or contextual data to one or more engine(s) (e.g., in a storage module(s) 220).

In this example, the devices include a power storage module 250. The power storage module(s) 250 may, for example, be operably coupled (not specifically shown) to provide power to the processor(s) 205 and/or other components (e.g., directly, indirectly). The power storage module(s) 250 may, for example, include a battery. The power storage module(s) 250 may include, for example, a power port and/or associated circuitry. The power storage module(s) 250 may include, for example, a charge control and/or power supply circuit(s).

The PRID 130 includes one or more sensors 230. The sensor 230 may, for example, detect child interactions. The sensors 230 may, by way of example and not limitation, include various types of sensors configured to detect environmental conditions and/or child interactions. The sensors 230 may, for example, include motion sensors. Motion sensors may, for example, advantageously enable detection of physical activity levels and/or gestures. The sensors 230 may, for example, include proximity sensors. Proximity sensors may, for example, advantageously enable detection of approach and/or engagement distances. The sensors 230 may, for example, include touch sensors. Touch sensors may, for example, advantageously enable detection of direct physical interaction patterns. The sensors 230 may, for example, include microphones. Microphones may, for example, advantageously enable detection of voice commands and/or ambient noise levels. The sensors 230 may, for example, include optical sensors. Optical sensors may, by way of example and not limitation, include cameras. Cameras may, for example, advantageously enable detection of facial expressions and/or visual engagement. The sensors 230 may provide input data to the response generation engine 225. The sensor data may, for example, advantageously enable context-aware and/or interactive responses.

The PRID 130 includes one or more actuators 235 configured to generate responses. The actuators 235 may, for example, include various types of output devices configured to generate responses (e.g., for child interaction). The actuators 235 may, for example, include displays. A display may, for example, include an LED array. Displays may, for example, advantageously enable dynamic visual feedback visible from multiple viewing angles. The actuators 235 may, for example, include speakers. Speakers may, for example, advantageously provide rich auditory feedback and/or verbal encouragement. The actuators 235 may, for example, include haptic feedback devices. Haptic feedback devices may, for example, advantageously provide physical feedback that reinforces interactions. The actuators 235 may, for example, include lights. Lights may, for example, advantageously capture attention through dynamic visual effects. The actuators 235 may, for example, include mechanical actuators. Mechanical actuators may, for example, advantageously enable novel physical interaction patterns. The actuators 235 may receive commands from the response generation engine 225 to deliver responses in various modalities suited for child engagement.

FIG. 2B depicts an example configuration in which the HMI 110 transmits information to the PRID 130. The PRID 130 contains the index generation engine 255. The index generation engine 255 may, for example, transform information (e.g., RII packages of raw data) into an index form (e.g., prior to processing by the response generation engine 225. The configuration shown in FIG. 2B may, for example, advantageously reduce processing demand on the HMI 110.

FIG. 2C depicts an example configuration in which the HMI 110 transmits information to a cloud network 265 (e.g., elastic computing network). The index generation engine 255 is hosted on the cloud network 265. The index generation engine 255 may, for example, transform the data from the HMI 110 (e.g., pre-index parent response data) to an index (e.g., aggregated, synthesized, weighted). The PRID 130 may, for example, receive the output of the index generation engine 255 (e.g., the index output). The PRID 130 may, for example, generate (e.g., from the index output) control signal(s) for the actuator(s) 235. A cloud intermediated system may, for example, advantageously enable remote communication (e.g., when the parent is at work). The cloud system may, for example, reduce computing demand on the HMI 110 and/or the PRID 130.

FIG. 3 depicts an illustrative method 300 for initializing and/or configuring the parent- responsive interactive system. The method begins at step 305 with initialization of the HMI 110 and/or PRID 130. At step 310, the HMI 110 and PRID 130 are communicably coupled (e.g., wirelessly paired). At step 315, the method checks if coupling was successful. If not, the method returns to step 310.

The initialization step 305 may, for example, include power-on self-test operations. For example, the system may verify proper operation of sensors, actuators, and/or communication systems. Comprehensive initialization may, for example, advantageously ensure reliable system operation.

The coupling step 310 may, for example, include wireless pairing operations. For example, the HMI 110 and PRID 130 may establish secure Bluetooth connections (e.g., with mutual authentication). Secure pairing may, for example, advantageously prevent unauthorized access to the system.

If coupling is successful, the method proceeds to step 320 to check whether custom input configurations are to be used. If custom inputs are determined to be used (e.g., selected by the user such as instead of default), the method receives (e.g., retrieves, prompts the user for) and sets custom input parameters at step 325. At step 330, the method checks whether to use custom interaction configurations. If custom interactions are determined to be used (e.g., selected by the user, such as instead of default), these are received and/or set at step 335. At step 340, the method checks if adaptive transformation is desired. If so, adaptive models such as machine learning models are connected at step 345 before the method ends.

The custom input configuration step 325 may, by way of example and not limitation, include defining input parameters. For example, parents may customize rating scales, observation categories, and/or input methods. Custom input configuration may, for example, advantageously enable personalized interaction patterns.

The custom interaction configuration step 335 may, by way of example and not limitation, include defining response parameters. For example, parents may customize types of feedback, intensity levels, and/or timing of responses. Parents may, for example, customize messages (e.g., naughty / nice, good / needs improvement), scales, and/or indicia types and/or patterns. Custom interaction configuration may, for example, advantageously enable age-appropriate engagement.

The adaptive model connection step 345 may, as depicted in this example, include linking machine learning models. For example, natural language processing models may be connected to analyze text inputs. Adaptive models (e.g., large language models (LLMs)) may, by way of example and not limitation, advantageously enable sophisticated interpretation of unstructured inputs.

FIG. 4 depicts an illustrative method 400 for operation of the HMI 110. The depicted method begins at step 405 with receiving observations from the parent 105. At step 410, an RII package is generated based on the observations. The RII package is transmitted to the PRID 130 at step 415. At step 420, the method checks if further observations are to be received. If yes, the method returns to step 405, otherwise the method ends.

The observation reception step 405 may, for example, include receiving multiple input types. For example, the system may receive numerical ratings, text descriptions, and/or voice recordings. Multi-modal input reception may, for example, advantageously capture rich behavioral context.

The RII package generation step 410 may, for example, include data fusion operations. For example, multiple parent inputs may be combined and/or normalized into a single interaction index (e.g., by the index generation engine 255). Data fusion may, for example, advantageously enable consistent response generation from varied inputs.

The RII package transmission step 415 may, for example, include secure data transfer. For example, encrypted RII packages may be transmitted using authenticated connections. Secure transmission may, for example, advantageously protect sensitive behavioral data.

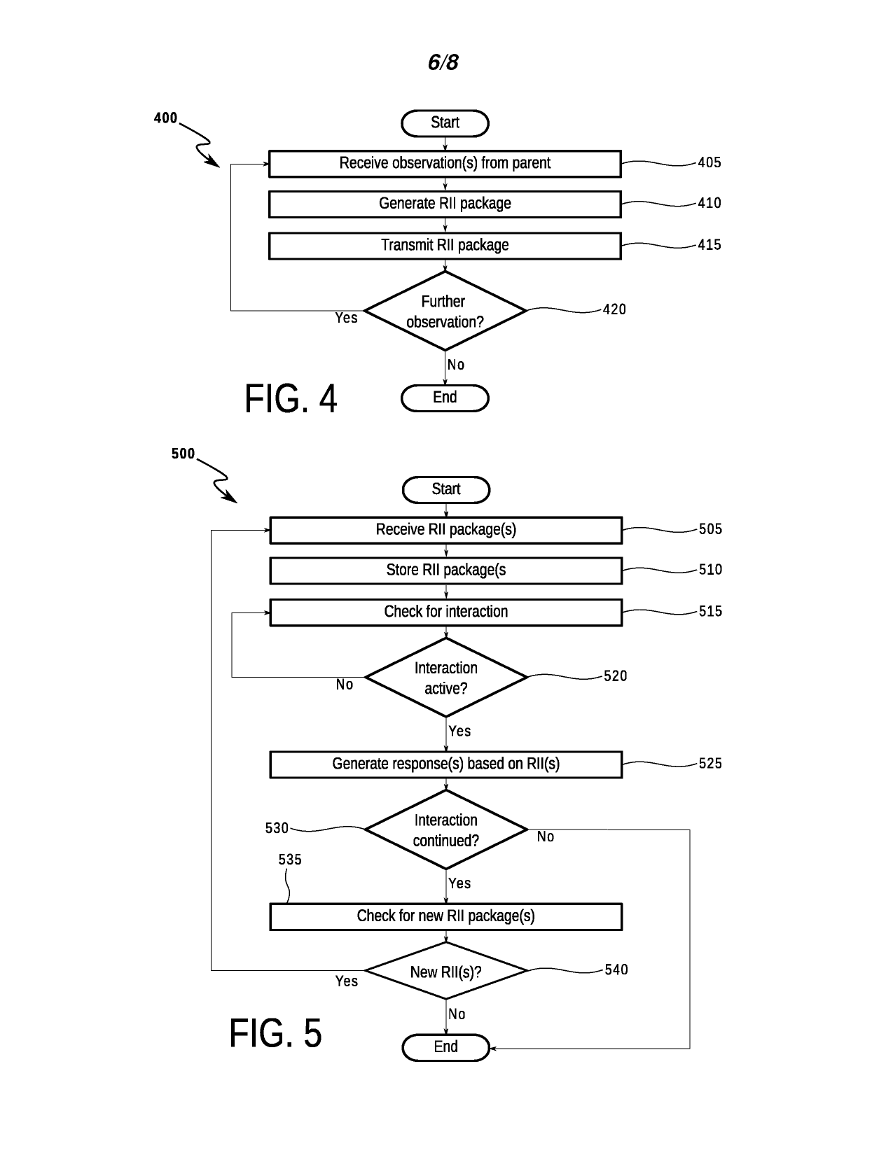

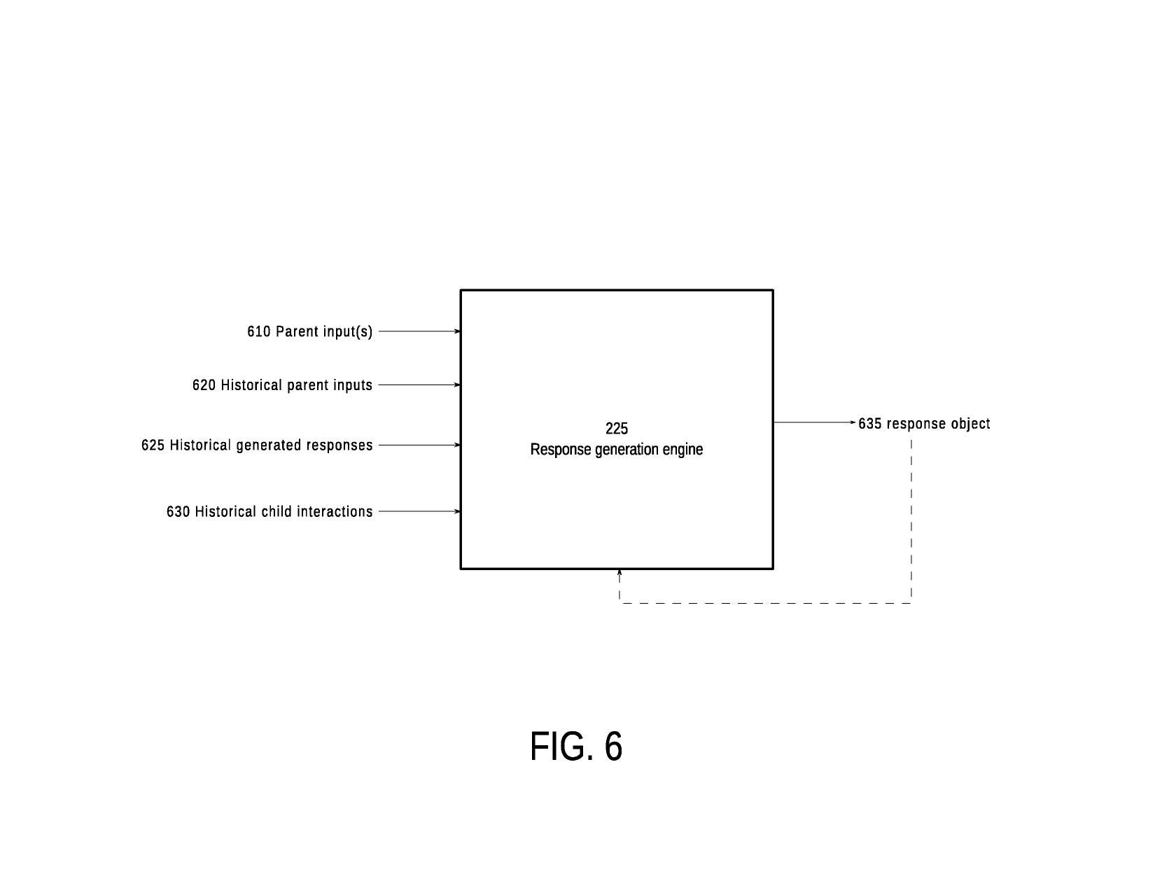

FIG. 5 depicts an illustrative method 500 of operation of the PRID 130. The method begins at step 505 with receiving one or more RII packages. At step 510, the received RII packages are stored. The method checks for interaction events at step 515. If an interaction is active as determined at step 520, the method generates one or more responses based on the stored RII packages at step 525. At step 530, the method checks if interaction is continuing. If yes, at step 535 the method checks for new RII packages. If new packages are detected at step 540, the method returns to step 505 to process them. If no new packages are detected, the method returns to step 515 to continue checking for interactions. If interaction is not continuing at step 530, the method ends.

The RII package reception step 505 may, for example, include verification operations. For example, received packages may be validated for authenticity and/or completeness. Reception verification may, for example, advantageously ensure data integrity.

The interaction checking step 515 may, by way of example and not limitation, include monitoring multiple sensor inputs. For example, touch, motion, and/or proximity sensors (e.g., sensor(s) 230) may be monitored for interaction events. Multi-sensor monitoring may, for example, advantageously enable natural interaction detection.

The response generation step 525 may, for example, include context-aware operations. For example, responses may be generated based on time of day, recent interactions, and/or stored RII packages. Context-aware generation may, for example, advantageously enable appropriate and/or effective responses.

FIG. 6 depicts an illustrative block diagram depicting operation and/or training of an example response generation engine 225. In the depicted example, the response generation engine 225 is configured to receive one or more inputs and/or generate a response object(s) 635 in response. As depicted, the inputs include parent input(s) 610. The parent input(s) 610 may, for example, include numerical ratings of child behavior. Numerical ratings may advantageously provide normalized metrics for response generation. The parent input(s) 610 may, for example, include categorical assessments like "Very Good" or "Needs Improvement." Categorical assessments may, for example, advantageously enable consistent evaluation frameworks. The parent input(s) 610 may, for example, include free-form text descriptions of specific behaviors. Free-form descriptions may advantageously capture nuanced behavioral context.

In the depicted embodiment, inputs include historical parent input(s) 620. The historical parent input(s) 620 may, for example, include past numerical ratings. The historical parent input(s) 620 may, for example, include past categorical assessments. The historical parent input(s) 620 may, for example, include past text descriptions. Historical parent input data may advantageously enable identification of behavioral patterns and/or trends.

As shown, inputs include historical generated responses 625. The historical generated responses 625 may, for example, include past visual display patterns. Visual response history may advantageously, for example, inform selection of effective visual feedback. The historical generated responses 625 may, for example, include past audio responses. Audio response history may, for example, advantageously guide development of engaging sound patterns. The historical generated responses 625 may, for example, include past haptic feedback patterns. Haptic response history may, for example, advantageously enable optimization of physical feedback.

The depicted inputs include historical child interactions 630. The historical child interactions 630 may, for example, include past touch interactions. Touch interaction history may, for example, advantageously inform physical engagement patterns. The historical child interactions 630 may, for example, include past motion interactions. Motion interaction history may, for example, advantageously guide development of movement-based responses. The historical child interactions 630 may, for example, include past proximity interactions. Proximity interaction history may, for example, advantageously enable optimization of distance-based responses.

The inputs may include associations between corresponding historical data. For example, associations may correlate historical parent input(s) 620 with historical generated responses 625. Response-input associations may, for example, advantageously enable analysis of feedback effectiveness. For example, associations may correlate historical generated responses 625 with historical child interactions 630. Response-interaction associations may advantageously inform engagement optimization, for example. For example, associations may correlate historical parent input(s) 620 with historical child interactions 630. Input-interaction associations may, for example, advantageously enable behavioral pattern recognition.

The response generation engine 225 generates response object(s) 635 based on the received inputs. The response object(s) 635 may, for example, include visual display commands for LED arrays. LED display commands may advantageously enable dynamic visual feedback. The response object(s) 635 may, for example, include audio playback instructions. Audio instructions may advantageously provide rich auditory engagement. The response object(s) 635 may, for example, include haptic activation patterns. Haptic patterns may advantageously enable physical reinforcement of interactions.

The response object(s) 635 may be used to control actuator(s) 235 of the PRID 130. For example, the response object(s) 635 may control LED brightness and/or color patterns. For example, the response object(s) 635 may control speaker volume and/or sound selection. For example, the response object(s) 635 may control vibration intensity and/or duration.

The response generation engine 225 may be trained using historical data of associated inputs and outputs. In some embodiments, the historical data may, for example, be split into training data and test data. The response generation engine 225 may be trained, for example, on the training data to generate response objects. The trained response generation engine 225 may, for example, be tested by applying it to the test data inputs and comparing generated response objects to actual historical responses. If an accuracy metric comparing generated and actual responses meets an accuracy threshold, the training may, for example, be considered complete. If the accuracy threshold is not met, the response generation engine 225 may be re-trained, for example, potentially with additional training data and/or modified parameters, until the accuracy threshold is achieved. This training process may, for example, advantageously enable optimization of response generation based on historical interaction patterns.

In this example, the inputs may be generated from responsive interaction index (RII) packages from the HMI 110. The RII packages may, for example, include aggregated parent input data regarding child behavior. The RII packages may, for example, advantageously provide normalized behavioral metrics for generating appropriate responses.

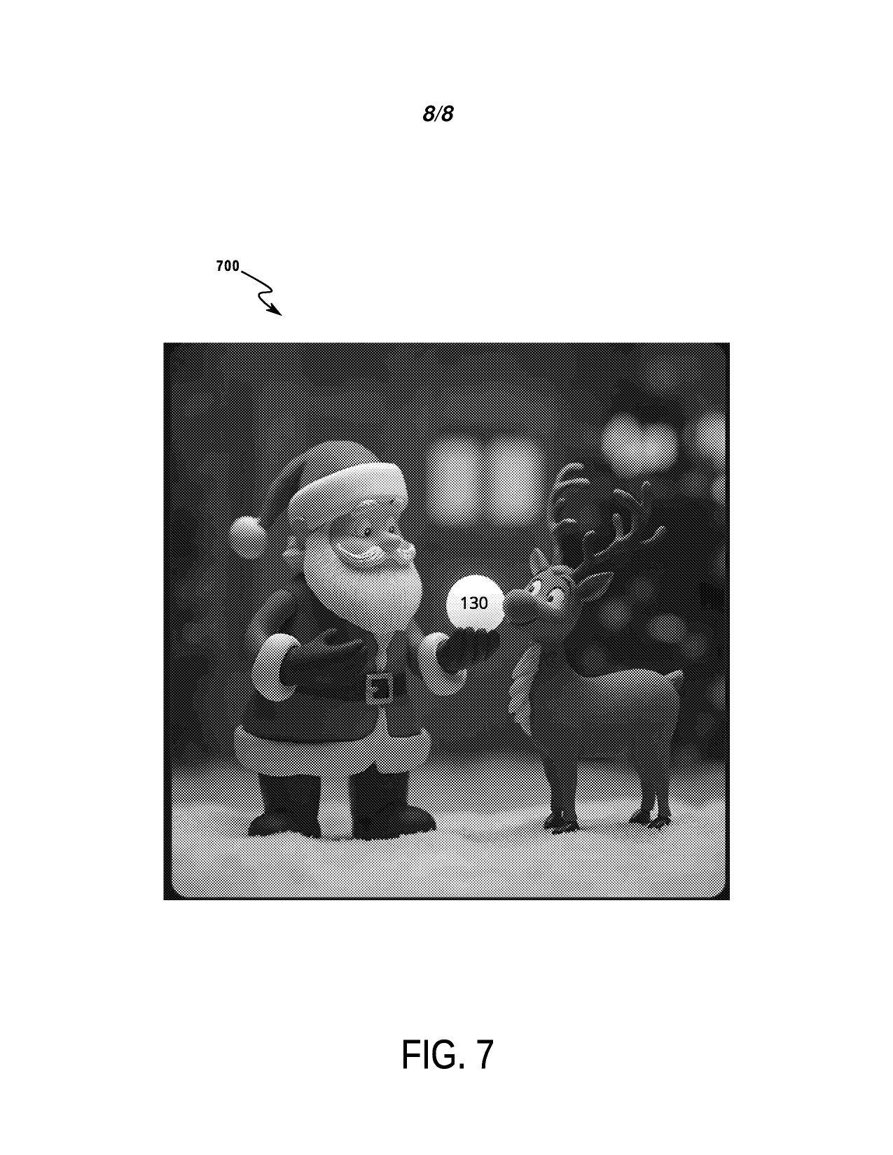

FIG. 7 depicts an illustrative embodiment of a child's toy 700 including a PRID 130. The PRID 130 may, for example, be removable (e.g., from the hand of the Santa character). An animation sequence may, for example, induce operation of various actuators of one or more characters and/or the PRID 130.

Although various embodiments are shown and described, other embodiments are contemplated. For example, although parents and/or children are mentioned in various examples, other users are contemplated. Caretakers, siblings, grandparents, and/or other blood or other relations may operate the system (e.g., providing input(s) to an HMI 110). Friends may, by way of example and not limitation, operate an HMI 110 and/or corresponding PRID 130. Teachers may, for example, operate an HMI 110 and/or corresponding PRID 130. Some embodiments may, for example, be configured specifically for a certain type of operator (e.g., parent, sibling, grandparent, aunt, uncle, nephew, niece, child, grandchild, friend, caregiver, teacher, medical professional, patient). In some examples, the PRID 130 may be configured to interact through a remote control. For example, an HMI 110 may be configured as a dedicated remote control device. The remote control device may, for example, include predetermined RII input options (e.g., "naughty," "nice") and/or operational controls (e.g., on/off, "pair"). A dedicated remote control device may, for example, advantageously enable a user (e.g., parent) to control the PRID 130 without needing a smartphone and/or having to download and/or configure an app.

In some embodiments, the PRID 130 may, for example, have a control interface (e.g., buttons, touch inputs, switches, sliders). The control interface may, for example, be integrated into the PRID 130 and/or a base configured to couple to the PRID 130. The control interface may, for example, advantageously allow a user (e.g., parent) to control the PRID 130 without having to locate a separated HMI 110.In some examples, the PRID 130 may include a charging module. The charging module may, for example, be configured to couple to a power source and charge a power storage module 250. The charging module may, for example, be configured to wirelessly couple to a power source. A wireless charging module may, by way of example and not limitation, include an induction charging receiver. As an illustrative example, a base may, for example, be configured to chargingly couple to the PRID 130. For example, the child's toy 700 may be configured to connect to power (e.g., plug-in to a wall outlet). The PRID 130 may, for example, be releasably coupled to the child's toy 700 (e.g., the Santa figurine). The child's toy 700 may, for example, include a charging module (e.g., wireless, spring-loaded pin). When the PRID 130 is docked (e.g., placed in the hand of the Santa figurine), the PRID 130 may, for example, be charged. Such embodiments may, for example, advantageously encourage the child to dock the PRID 130. In some examples, the PRID 130 and/or the base (e.g., the child's toy 700) may provide indicia (e.g., colors, animations, text, icons) indicating the PRID 130 should be charged. The PRID 130 and/or the base may, for example, provide 'rewards' (e.g., hidden animations, mechanical actions such as raising Santa's hand or moving the reindeer) when the PRID 130 is docked.

In some examples, such as shown in FIG. 7, the PRID 130 may, for example, be configured as a kit. A kit may, for example, include a PRID 130. The kit may include, for example, an HMI 110. In some examples, a kit may include a charger (e.g., wall charger, wireless charger). The kit may include, for example, a decorative docking and/or storage station. Instructions may, for example, be included in the kit. A book and/or other media object (e.g., DVD, flash drive with interactive media, card with QR code linking to online media) may be included in a kit, for example. In some examples, multiple components (e.g., duplicates, variants) may be included in a kit. In some embodiments, a kit may be modularly configured (e.g., 'customized'), such as by a purchaser, for example.

The PRID 130 may be configured with various display technologies. For example, the PRID may incorporate micro-projectors. A projector(s) may, for example, be configured to generate dynamic light patterns and/or other visual effects. The micro-projectors may, for example, advantageously enable projection onto internal surfaces of the device housing and/or external surfaces to create engaging visual displays.

Some HMI configurations may, for example, include voice-activated interface(s) and/or gesture recognition system(s). For example, some embodiments may be configured such that caregivers may provide feedback through voice commands (e.g., captured by integrated and/or remote microphones, such as via smartphones). Voice commands may, for example, advantageously enable hands-free operation while attending to children. For example, some embodiments may be configured such that caregivers may provide feedback through gesture recognition systems. Gesture recognition may, for example, advantageously allow natural, intuitive interaction with the device.

The PRID 130 may, for example, include integrated microphone(s) configured to detect specific verbal triggers from users (e.g., children). For example, the PRID 130 may be configured such that, when a child says predetermined phrases like "good morning" or "thank you or "am I naughty or nice?," the device may activate (e.g., with a light pattern(s), such as a dynamically determined pattern corresponding to a current RII package). Voice-activated responses may, for example, advantageously reinforce positive verbal interactions through immediate feedback.

In some embodiments, the PRID 130 may, for example, be themed for different occasions and/or seasons. For example, some versions may be configured to be independent of a specific holiday and/or event. Some versions may, for example, feature sun and/or moon motifs (e.g., advantageously configured for year-round use). Year-round themes may advantageously maintain child engagement beyond holiday periods, for example. In some examples, the PRID 130 may, for example, be configured with sports-themed designs (e.g., beach balls, basketballs). Sports themes may, for example, advantageously appeal to athletically-inclined children. For example, in some embodiments a PRID 130 may, for example, be configured with nature-inspired themes (e.g., flowers, trees, animals). Nature themes may, for example, advantageously help connect children with outdoor life. In various embodiments discussed here and/or elsewhere herein, a theme and/or visual aesthetic may extend beyond or instead of to associated devices (e.g., as shown in FIG. 7). As an illustrative example, a themed PRID 130 may be configured for use with a themed environment (e.g., a nature display, a beach scene, a sports toy). A non-themed PRID 130 may, for example, be configured for use with multiple themed environments. Such embodiments may, for example, advantageously enable a single PRID 130 to be used across multiple events, and/or seasons.

In some embodiments, a housing (e.g., of the PRID 130) may be configured in various shapes such as, for example, beyond spherical designs. For example, the housing may be shaped like a snowman. Snowman shapes may, for example, advantageously coordinate with winter themes. For example, the housing may be shaped like an animal (e.g., bunny). Animal shapes may, for example, advantageously appeal to spring themes. For example, the housing may be shaped like a star. Star shapes may, for example, advantageously provide versatility across multiple holidays and/or seasons.

In some examples, a PRID may be configured for a medical environment. For example, a PRID may be configured to provide feedback to patients undergoing physical therapy rehabilitation. The PRID may, for example, generate encouraging responses when proper therapeutic movements are detected. Response-based rehabilitation feedback may advantageously increase patient engagement and/or adherence to prescribed exercises. For example, a PRID may be configured to provide feedback to patients managing chronic conditions. The PRID may, for example, generate calming responses when anxiety or stress indicators are detected. Stress-responsive feedback may advantageously help patients develop self-regulation strategies.

In some implementations, a PRID may be configured for an educational environment. For example, a PRID may be configured as an interactive learning companion for students practicing reading skills. The PRID may, for example, generate positive responses when students successfully read passages aloud. Reading-responsive feedback may advantageously reinforce literacy development through immediate positive reinforcement. For example, a PRID may be configured to support mathematics education. The PRID may, for example, generate encouraging responses when students solve problems correctly. Mathematics-responsive feedback may advantageously build student confidence through consistent acknowledgment of achievements.

Some embodiments may, for example, be implemented in a special education environment. For example, a PRID may be configured to provide feedback to students with autism spectrum disorders. The PRID may, for example, generate calming responses when overstimulation is detected. Sensory-aware feedback may advantageously help students develop self-regulation skills. For example, a PRID may be configured to support speech therapy. The PRID may, for example, generate responses that reinforce proper pronunciation patterns. Speech-responsive feedback may advantageously encourage continued practice of therapeutic exercises.

Some embodiments may include implementations where the interactive toy displays the dynamic indication in response to detecting that the child has initiated interaction with the toy. For example, the child may shake the interactive toy, touch a sensor on the toy, move near the toy, speak to the toy, and/or pick up the toy. Detection of such child-initiated interactions may trigger the response generation engine to select and display an appropriate dynamic indication from the plurality of predetermined indications. Child-initiated triggering may advantageously create an engaging interactive experience where the child actively participates in receiving behavioral feedback. For example, the sensors may include motion sensors, touch sensors, proximity sensors, and/or microphones configured to detect various types of child-initiated interactions. When the child initiates interaction, the response generation engine may retrieve the most recent RII package and select a dynamic indication based on the aggregated index contained in that package.

The dynamic indication may display a single present representation of the time-distributed parent-provided behavioral indicators. For example, rather than displaying individual parent observations (e.g., "Mom rated you 8/10 on Monday, 6/10 on Tuesday"), the interactive toy may display a single unified indicator (e.g., a specific color pattern, light intensity, or animation) that represents an aggregation of all the time-distributed observations. This single present representation may advantageously provide the child with a clear, non-explicit behavioral signal without overwhelming the child with detailed historical data and/or direct parental messages. For example, if the aggregated index indicates generally positive behavior over the past week, the interactive toy may display a warm green glow. If the aggregated index indicates behavior needing improvement, the interactive toy may display a cooler blue pulse. The single present representation may advantageously enable the child to understand their overall behavioral status through a simple, intuitive visual indicator.

In some embodiments, the response generation engine may store a plurality of predetermined indications. For example, the plurality of predetermined indications may include different LED color patterns (e.g., green glow, yellow pulse, red flash), different snow globe animations (e.g., gentle swirl, moderate agitation, vigorous shaking), different audio patterns (e.g., cheerful melody, neutral tone, contemplative sound), and/or different haptic feedback patterns (e.g., gentle vibration, pulsing vibration, steady vibration). Each predetermined indication may correspond to a range of aggregated index values. The response generation engine may select the most appropriate predetermined indication based on comparing the current aggregated index value to threshold values associated with each predetermined indication. Predetermined indications may advantageously enable consistent, predictable behavioral feedback that children can learn to interpret over time. For example, a child may learn that a green glow indicates positive behavioral patterns, while a blue pulse indicates areas for improvement.

The parent-provided behavioral indicators may be time-distributed. For example, parents may provide behavioral observations at various times throughout a day, week, and/or month. The observations may be timestamped to record when each observation was made. Time-distributed observations may advantageously enable the system to track behavioral patterns over time rather than relying on single-point-in-time assessments. For example, a parent may observe and record a child's behavior in the morning before school, in the afternoon after school, and in the evening before bed, creating a time-distributed set of behavioral indicators. These time-distributed indicators may be transmitted to the index generation engine as they are recorded, and/or may be batched and transmitted periodically. The index generation engine may process the time-distributed indicators to compute the aggregated index, which may reflect behavioral patterns across the time period during which observations were recorded.

In some embodiments, at least some of the time-distributed parent-provided behavioral indicators may be provided at times when the child is not interacting with the interactive toy. For example, a parent may observe the child's behavior during dinner, at school pickup, during homework time, and/or during bedtime routines, and may input these observations into the HMI while the interactive toy is stored away, powered off, and/or the child is not present. The child may later initiate interaction with the toy (e.g., hours and/or days after the parent provided the observations), at which point the toy displays a dynamic indication based on the aggregated index derived from those earlier observations. Asynchronous observation input may advantageously enable parents to document behavioral observations whenever they occur, without requiring the child to be present with the toy and/or requiring the toy to be active. For example, a parent may observe positive behavior at a soccer game on Saturday afternoon and input that observation into the HMI while driving home. On Sunday morning, when the child initiates interaction with the toy, the toy may display a dynamic indication that reflects the positive observation from the previous day, along with other time-distributed observations.

In some embodiments, the response generation engine may select the dynamic indication by comparing the aggregated index value to a plurality of threshold values. For example, if the aggregated index ranges from 0-100, threshold values may be set at 33, 66, and 100. An index value of 0-33 may correspond to a first predetermined indication (e.g., blue pulsing light indicating behavior needing improvement), an index value of 34-66 may correspond to a second predetermined indication (e.g., yellow steady light indicating acceptable behavior), and an index value of 67-100may correspond to a third predetermined indication (e.g., green glowing light indicating positive behavior). The response generation engine may compare the current aggregated index value received in the RII package to these thresholds to select the most appropriate predetermined indication. Threshold-based selection may advantageously provide clear, consistent mapping between behavioral indices and displayed feedback. For example, the thresholds may be customizable during the configuration process described with reference to FIG. 3, enabling parents to adjust sensitivity of the feedback system to match their child's developmental stage and/or behavioral goals.

In some embodiments, the aggregated index may be derived by computing a weighted average of the plurality of time-distributed parent-provided behavioral indicators. For example, more recent behavioral indicators may be assigned higher weights than older indicators, which may emphasize current behavioral patterns while maintaining historical context. As an illustrative example, observations from the past 24 hours may be weighted at 1.0, observations from 2-7 days ago may be weighted at 0.5, and observations older than 7 days may be weighted at 0.25. The weighted average may be computed by the index generation engine by multiplying each observation value by its weight, summing the weighted values, and dividing by the sum of the weights. Weighted averaging may advantageously enable the system to reflect recent behavioral changes while maintaining historical context. For example, if a child exhibited challenging behavior earlier in the week but has shown improvement in recent days, the weighted average may reflect the positive trajectory, which may encourage continued positive behavior.

In some embodiments, the time-distributed parent-provided behavioral indicators may be provided by a biological parent of the child. In other embodiments, the indicators may be provided by adoptive parents, foster parents, legal guardians, caregivers, siblings, teachers, grandparents, aunts, uncles, coaches, counselors, and/or other individuals involved in the child's care and development. For example, a teacher may input observations about classroom behavior during the school day, while a parent inputs observations about home behavior in the evening. The index generation engine may aggregate these observations from multiple sources to compute a comprehensive behavioral index. Multi-source behavioral input may advantageously provide a more complete picture of the child's behavior across different contexts and environments. For example, a child may exhibit different behaviors at school versus at home, and aggregating observations from both contexts may provide more balanced feedback.

The HMI may include a smartphone, tablet computer, desktop computer, smart television, and/or dedicated remote control device. For example, a smartphone implementation may enable parents to input behavioral observations using a mobile application while away from home. A desktop computer implementation may provide a larger display and more robust processing capabilities for managing multiple children's behavioral data and/or reviewing historical trends. A smart television implementation may enable parents to input behavioral observations using familiar television interfaces and remote controls, which may advantageously reduce the learning curve for less technologically-inclined parents. A dedicated remote control device implementation may include predetermined RII input options (e.g., buttons labeled "positive behavior," "needs improvement") and/or operational controls (e.g., on/off, pair), which may advantageously enable parents to provide quick behavioral inputs without needing to unlock a smartphone and/or navigate through an application interface.

In some embodiments, the RII package may include a numerical index value representing the aggregated index. For example, the numerical index value may range from 0-100, where higher values indicate more positive behavioral patterns and lower values indicate behaviors needing improvement. Numerical representation may enable precise mathematical operations such as weighted averaging, threshold comparisons, and trend analysis. The RII package may include a timestamp indicating when the aggregated index was computed. The timestamp may enable the PRID to determine the recency of behavioral data and/or prioritize more recent indices when multiple RII packages have been received. Timestamps may help synchronize behavioral feedback with current child behavior patterns. For example, if the PRID receives an RII package with a timestamp from several days ago and another RII package with a current timestamp, the response generation engine may prioritize the more recent package when selecting the dynamic indication.

In some embodiments, the RII package may be generated by an index generation engine hosted on a cloud computing network. The cloud computing network may include distributed servers, virtualized computing resources, and/or elastic scaling capabilities. Cloud-hosted index generation may advantageously enable remote communication between the HMI and the PRID when they are not in close proximity. For example, as described with reference to FIG. 2C, a parent may input behavioral observations into the HMI while at work, the observations may be transmitted to the cloud computing network where the index generation engine computes an updated aggregated index, and the updated RII package may be transmitted to the PRID at home. When the child later initiates interaction with the PRID, the toy may display a dynamic indication based on the parent's remote observations. Cloud-based processing may advantageously reduce computational demands on both the HMI and the PRID, which may extend battery life and/or enable use of less expensive hardware components.

In some embodiments, the interactive toy may be configured as an educational toy. For example, the PRID may incorporate educational content such as letters, numbers, shapes, colors, and/or educational animations into its dynamic indications. An educational toy configuration may combine behavioral reinforcement with learning opportunities. For example, when displaying a positive behavioral indication, the interactive toy may display a sequence of letters spelling an encouraging word, and/or may display numbers in an ascending pattern. When displaying an indication suggesting behavior needing improvement, the educational toy may display shapes in a contemplative pattern that encourages reflection. Educational toy configurations may advantageously provide dual benefits of behavioral feedback and cognitive development support.

Some embodiments may include one or more sensors operably coupled to the response generation engine and configured to detect the child initiating interaction with the interactive toy. The sensors may include motion sensors, touch sensors, proximity sensors, microphones, and/or cameras. Motion sensors may detect when the child picks up, shakes, and/or moves the interactive toy. Touch sensors may detect when the child touches specific areas of the toy's surface. Proximity sensors may detect when the child approaches the toy. Microphones may detect when the child speaks to the toy, such as asking predetermined questions (e.g., "Am I being good?"). Multi-sensor configurations may advantageously enable detection of various types of child-initiated interactions, which may create more natural and engaging interaction patterns. For example, as described with reference to FIG. 5, when sensors detect an interaction event at step 515, the response generation engine may generate and display a dynamic indication at step 525 based on the stored RII packages.

In some embodiments, the response generation engine may be configured to select the dynamic indication based on both detected child interactions and the aggregated index. For example, the type of interaction detected may influence which predetermined indication is selected from the plurality. If the child gently touches the toy, the response generation engine may select a subtle visual indication. If the child vigorously shakes the toy, the response generation engine may select a more dramatic visual indication. The intensity and/or type of the selected indication may be further modulated based on the aggregated index value. Interaction-responsive selection may advantageously create more engaging and contextually appropriate feedback. For example, a child who enthusiastically interacts with the toy may receive more animated feedback, while a child who tentatively approaches the toy may receive gentler feedback, with both types of feedback reflecting the underlying behavioral index.

The communication module may be configured to wirelessly receive the RII package via Bluetooth communication, Wi-Fi communication, and/or other wireless protocols. Bluetooth communication may advantageously enable direct device-to-device communication between the HMI and the PRID when they are in close proximity. Wi-Fi communication may advantageously enable communication through a local network and/or internet connection, which may support remote operation and/or cloud-based index generation as described with reference to FIG. 2C. For example, the communication module may establish a Bluetooth connection with the HMI during the pairing process described in FIG. 3, and may subsequently receive RII packages via that connection. In cloud-based configurations, the communication module may connect to a Wi-Fi network and receive RII packages from the cloud computing network hosting the index generation engine.

The time-distributed parent-provided behavioral indicators may include numerical ratings, categorical assessments, free-form text descriptions, voice recordings, and/or combinations thereof. Numerical ratings may include values on predetermined scales (e.g., 1-10 rating of behavior quality). Categorical assessments may include selections from preset categories (e.g., "Very Good," "Good," "Needs Improvement," "Challenging"). Free-form text descriptions may include detailed observations about specific behaviors and/or incidents, which may be processed by natural language processing models to extract behavioral indicators. Voice recordings may include audio notes about observations, which may be processed by speech recognition and/or sentiment analysis models to extract behavioral indicators. Multi-modal input options may advantageously enable parents to provide observations in whatever format is most convenient at the time of observation. For example, as described with reference to the parent interaction engine, a parent may quickly provide a numerical rating while busy with other tasks, and/or may provide a detailed text description when time permits more thorough documentation.

Some embodiments may include implementations where the index generation engine employs a trained machine learning model to generate the aggregated index from the plurality of time-distributed parent-provided behavioral indicators. For example, the machine learning model may be trained using historical behavioral indicator data and corresponding outcomes to learn patterns that predict appropriate index values. The training process may advantageously enable the system to generate aggregated indices that reflect complex behavioral patterns that may not be captured by simple mathematical operations such as averaging.

The machine learning model training process may include collecting historical training data. For example, the training data may include historical time-distributed parent-provided behavioral indicators paired with corresponding desired aggregated index values. The desired aggregated index values may be determined based on expert assessment, parent feedback regarding appropriateness of past responses, and/or observed child behavioral outcomes following display of dynamic indications. Historical training data may advantageously provide the foundation for learning effective index generation patterns.

In some embodiments, the training data may be preprocessed before model training. For example, preprocessing may include normalizing numerical ratings to common scales, converting categorical assessments to numerical representations, extracting sentiment scores from free-form text descriptions using natural language processing, and/or extracting behavioral indicators from voice recordings using speech recognition and sentiment analysis. Preprocessing may advantageously ensure that diverse input formats can be processed consistently by the machine learning model.

The machine learning model may include various architectures. For example, the model may include a neural network architecture such as a feedforward neural network, recurrent neural network (RNN), long short-term memory (LSTM) network, and/or transformer architecture. Neural network architectures may advantageously capture complex nonlinear relationships between behavioral indicators and appropriate index values. The model may include a decision tree architecture such as random forests and/or gradient boosted trees. Tree-based architectures may advantageously provide interpretable decision logic for index generation. The model may include a support vector machine (SVM) architecture. SVM architectures may advantageously provide robust classification of behavioral patterns into index value ranges.

In some embodiments, the training process may include splitting the historical data into training data and validation data. For example, 80% of the historical data may be designated as training data and 20% as validation data. The machine learning model may be trained on the training data by iteratively adjusting model parameters to minimize a loss function that measures the difference between predicted aggregated index values and actual desired index values. The trained model may be evaluated on the validation data to assess generalization performance. Data splitting may advantageously enable assessment of whether the model has learned generalizable patterns rather than memorizing the training data.

The loss function may include various formulations. For example, the loss function may include mean squared error (MSE) for regression tasks where the aggregated index is a continuous value. MSE may advantageously penalize large prediction errors more heavily than small errors. The loss function may include cross-entropy loss for classification tasks where the aggregated index represents discrete categories. Cross-entropy loss may advantageously encourage the model to assign high confidence to correct categories. The loss function may include custom weighted loss functions that penalize certain types of errors more heavily than others. For example, underestimating positive behavior (predicting a lower index than appropriate) may be penalized more heavily than overestimating, which may advantageously bias the system toward encouraging children.

In some embodiments, the training process may include hyperparameter tuning. For example, hyperparameters such as learning rate, number of hidden layers, number of neurons per layer, regularization strength, and/or batch size may be systematically varied to identify configurations that optimize validation performance. Hyperparameter tuning may be performed using grid search, random search, and/or Bayesian optimization techniques. Hyperparameter tuning may advantageously identify model configurations that maximize predictive accuracy while avoiding overfitting.

The trained machine learning model may receive as input the plurality of time-distributed parent-provided behavioral indicators. For example, the input may include a sequence of timestamped behavioral observations spanning a defined time window (e.g., past 7 days, past 30 days). Each observation may include numerical ratings, categorical assessments, and/or derived features from text and/or voice inputs. The model may process the input sequence to generate an aggregated index value as output. Sequential input processing may advantageously enable the model to learn temporal patterns in behavioral indicators, such as improving trends and/or declining trends.

In some embodiments, the machine learning model may incorporate attention mechanisms. For example, an attention mechanism may learn to assign different weights to different time- distributed behavioral indicators based on their relevance to the current behavioral status. More recent observations may automatically receive higher attention weights, while older observations may receive lower weights, without requiring manual specification of a weighting scheme. Attention mechanisms may advantageously enable the model to adaptively determine which observations are most relevant for computing the aggregated index.

The trained model may be periodically retrained using newly collected data. For example, as parents continue to provide behavioral indicators and children interact with the interactive toy, new training examples may be generated. The new training examples may include the behavioral indicators provided and the observed child responses to the displayed dynamic indications. If children respond positively (e.g., increased positive behaviors following display of encouraging indications), the corresponding index values may be reinforced as appropriate. If children do not respond as expected, the model may be adjusted to generate different index values for similar behavioral patterns. Periodic retraining may advantageously enable the system to continuously improve index generation based on real-world outcomes.

In some embodiments, the machine learning model may be personalized for individual children. For example, separate models may be trained for each child using that child's historical behavioral data. Personalized models may learn child-specific patterns, such as which types of behavioral indicators are most predictive of overall behavioral status for that particular child. Model personalization may advantageously enable more accurate and contextually appropriate index generation that accounts for individual differences in behavioral patterns and developmental stages.

The machine learning model may generate confidence scores along with aggregated index values. For example, the model may output both a predicted index value (e.g., 75 on a 0-100 scale) and a confidence score (e.g., 0.9 on a 0-1 scale) indicating the model's certainty in the prediction. Low confidence scores may trigger alerts to parents suggesting that additional behavioral observations may be needed to generate a reliable index. Confidence scoring may advantageously enable the system to communicate uncertainty and request additional input when needed.

In some implementations, the index generation engine may employ ensemble methods combining multiple machine learning models. For example, predictions from a neural network model, a random forest model, and a support vector machine model may be combined through weighted averaging and/or voting to generate the final aggregated index. Ensemble methods may advantageously improve prediction robustness by leveraging the strengths of different model architectures.

The machine learning model training and deployment may be performed on the cloud computing network, as described with reference to FIG. 2C. Cloud-based model training may advantageously leverage scalable computing resources for training complex models on large datasets. Cloud-based model deployment may advantageously enable centralized model updates that automatically propagate to all connected devices without requiring individual device updates.

Some embodiments may include a parent training mode configured to enable parents to customize the plurality of predetermined indications and/or the mapping between aggregated index values and selected indications. For example, the parent training mode may be implemented through the HMI, such as through a mobile application interface. Parent training mode may advantageously enable personalized response patterns that align with individual family values, child temperament, and/or parenting philosophies.

The parent training mode may include presenting a series of behavioral scenarios to the parent. For example, the HMI may display scenarios such as "Your child completed homework without being asked," "Your child shared toys with a sibling," "Your child refused to clean their room," and/or "Your child helped set the dinner table." Scenario-based training may advantageously help parents understand how different behavioral observations translate to system responses.

For each presented scenario, the parent may be prompted to provide a behavioral response. For example, the parent may input a numerical rating (e.g., 1-10), select a categorical assessment (e.g., "Very Good," "Good," "Needs Improvement"), and/or provide free-form text describing their assessment of the behavior. Parent-provided responses may advantageously enable the system to learn how the parent evaluates different types of behaviors.

In some embodiments, the parent training mode may simulate the aggregation process as multiple responses are collected. For example, after the parent has provided responses to three scenarios, the HMI may display a simulated aggregated index value (e.g., "Current Index: 72/100"). The simulated index may be computed using the same algorithms that would be used during actual system operation, such as weighted averaging and/or machine learning model prediction. Simulated aggregation may advantageously help parents understand how individual observations combine to form the overall behavioral index.

After presenting one or more scenarios and collecting parent responses, the parent may be prompted to select an appropriate indication for the interactive toy to display. For example, the HMI may present multiple indication options such as "warm green glow," "neutral yellow pulse," "cool blue flash," and/or "contemplative purple swirl." The parent may select which indication they believe would be most appropriate given the scenarios presented and the simulated aggregated index. Parent selection of indications may advantageously enable the system to learn parent preferences for mapping behavioral indices to displayed responses.

In some embodiments, the parent training mode may include visual previews of each indication option. For example, when the parent hovers over and/or taps an indication option on the HMI display, a video and/or animation may show how the interactive toy would display that indication. The preview may include visual effects (e.g., LED color patterns, snow globe animations), audio effects (e.g., sounds, melodies), and/or haptic effects (e.g., vibration patterns). Visual previews may advantageously help parents make informed selections by showing exactly what the child would experience.

The parent training mode may present scenarios in groups. For example, the training mode may present three scenarios, collect parent responses to all three scenarios, compute a simulated aggregated index based on those responses, and then prompt the parent to select an appropriate indication. After the parent selects an indication, the training mode may present another group of scenarios (e.g., three more scenarios), collect responses, update the simulated aggregated index, and prompt for another indication selection. Grouped scenario presentation may advantageously help parents understand how the aggregated index evolves as multiple behavioral observations accumulate over time.

In some implementations, the simulated aggregated index may change as additional parent responses are collected. For example, after the first group of three scenarios (e.g., all positive behaviors), the simulated index may be 85/100. After the second group of three scenarios (e.g., mixed positive and negative behaviors), the simulated index may decrease to 72/100. After the third group of three scenarios (e.g., mostly negative behaviors), the simulated index may decrease further to 58/100. Dynamic index progression may advantageously help parents understand how behavioral patterns over time influence the aggregated index and corresponding toy responses.

The parent training mode may track a confidence metric indicating the consistency of parent selections. For example, the confidence metric may be computed based on variance in parent selections for similar aggregated index values. If a parent consistently selects "warm green glow" when the simulated index is between 80-100, the confidence metric for that index range may increase. If parent selections vary widely for a particular index range (e.g., sometimes selecting "warm green glow" and sometimes selecting "neutral yellow pulse" for indices between 60-70), the confidence metric for that range may remain low. Confidence tracking may advantageously enable the system to identify which index ranges have well-established parent preferences and which may benefit from additional training.

The parent training mode may continue until a confidence threshold is reached. For example, the confidence threshold may be set such that all index ranges must have confidence scores above 0.8 on a 0-1 scale. The HMI may display progress indicators showing which index ranges have reached the confidence threshold and which require additional training. When the confidence threshold is reached across all index ranges, the training mode may automatically complete and apply the learned mappings to the response generation engine. Threshold-based completion may advantageously ensure that the system has sufficient training data before deploying customized response patterns.

In some embodiments, the parent may manually complete the training mode before the confidence threshold is reached. For example, the HMI may display a "Complete Training" button that becomes available after a minimum number of scenario groups have been completed (e.g., five groups of three scenarios each, totaling fifteen scenarios). The parent may select this option if they feel confident in their selections even if the system-computed confidence metric has not reached the threshold for all index ranges. Manual completion may advantageously provide flexibility for parents who prefer to begin using the system quickly rather than completing extensive training.

The parent training mode may generate customized threshold values based on parent selections. For example, if a parent consistently selects "warm green glow" when the simulated index is above 75, the system may set a threshold at 75 such that index values of 75 and above trigger selection of "warm green glow." If a parent consistently selects "cool blue flash" when the simulated index is below 40, the system may set a threshold at 40 such that index values below 40 trigger selection of "cool blue flash." If a parent consistently selects "neutral yellow pulse" when the simulated index is between 40-75, the system may set thresholds at 40 and 75 to define that range. Learned threshold generation may advantageously create personalized response mappings that reflect individual parent judgment about appropriate feedback intensity.

In some implementations, the parent training mode may employ machine learning models to predict parent preferences. For example, a classification model may be trained on the parent's scenario-response-indication triplets to predict which indication the parent would select for new scenario combinations and index values. The trained model may be used to pre-populate indication selections for subsequent scenario groups, which the parent can accept and/or modify. Predictive modeling may advantageously reduce the number of manual selections required while still enabling parent oversight and correction.

The parent training mode may include explanatory feedback to help parents understand the implications of their selections. For example, after a parent selects an indication for a scenario group, the HMI may display a message such as "This selection indicates you prefer encouraging feedback when the index shows generally positive behavior" and/or "This selection suggests you prefer gentle correction when the index shows mixed behavior patterns." The HMI may display how the selected indication compares to expert-recommended defaults for similar index values. Explanatory feedback may advantageously help parents reflect on their parenting approach and ensure their selections align with their intended parenting philosophy.

In some embodiments, the parent training mode may vary the types of scenarios presented. For example, early scenario groups may focus on clearly positive behaviors (e.g., "Your child helped a friend") and clearly negative behaviors (e.g., "Your child hit a sibling"). Later scenario groups may present more ambiguous situations (e.g., "Your child completed homework but complained throughout"). Scenario variety may advantageously help the system learn parent preferences across the full spectrum of behavioral situations.

The parent training mode may adapt the number of scenarios presented based on confidence metric progression. For example, if confidence metrics are increasing rapidly (indicating consistent parent selections), the training mode may present fewer scenario groups before prompting for indication selection. If confidence metrics are increasing slowly (indicating variable parent selections), the training mode may present more scenario groups to gather additional data. Adaptive scenario presentation may advantageously optimize training efficiency while ensuring sufficient data collection.

In some embodiments, the parent training mode may be repeated and/or updated over time. For example, parents may re-enter training mode to adjust response mappings as their child develops and/or as family circumstances change. A child who initially responded well to subtle feedback may benefit from more explicit feedback as they mature. A child experiencing stress from a family transition may benefit from gentler feedback temporarily. The HMI may prompt parents to review and/or update their training selections periodically (e.g., every three months, every six months). Iterative training may advantageously enable the system to adapt to changing family dynamics and child developmental stages.

The parent training mode may support multiple parent profiles. For example, if both parents use the HMI, each parent may complete separate training sessions. The system may aggregate the two parents' preferences to generate consensus response mappings by averaging threshold values, identifying commonly selected indications, and/or weighting preferences based on which parent provides more frequent behavioral observations. The system may enable parents to review and discuss differences in their selections through a comparison interface showing where their threshold preferences diverge. Multi-parent training may advantageously promote parental alignment on behavioral feedback approaches and/or accommodate different parenting styles within the same household.

In some implementations, the parent training mode may include expert-recommended default mappings. For example, the system may provide pre-configured response mappings developed by child development experts, child psychologists, and/or behavioral specialists, which parents can use as a starting point before customizing. The expert defaults may vary based on child age ranges (e.g., toddler defaults, preschool defaults, elementary school defaults). Parents may select to use expert defaults without modification, use expert defaults as a starting point for customization, and/or create fully custom mappings without reference to defaults. Expert defaults may advantageously provide guidance for parents who are uncertain about appropriate feedback intensity and/or patterns.

The parent training mode may store training data in the data store. For example, all scenario- response-indication triplets selected by parents may be stored along with timestamps, simulated aggregated index values, and confidence metrics. Historical training data may advantageously enable analysis of how parent preferences evolve over time and/or inform improvements to the training mode interface and algorithms. Historical training data may enable the system to detect significant changes in parent preferences over time, which may trigger prompts to review and confirm whether the changes are intentional.

In some embodiments, the parent training mode may be integrated with the configuration process described with reference to FIG. 3. For example, the training mode may be presented as an optional step after the custom interaction configuration step 335. Parents who wish to use default response mappings may skip the training mode, while parents who prefer personalized mappings may complete the training process before beginning regular system operation. The configuration process may provide recommendations about whether to use default mappings and/or complete training mode based on factors such as child age, parent experience with similar systems, and/or time availability.

Some embodiments may encompass various components, display technologies, chip technologies, interface technologies, power supply technologies, power storage technologies, server architectures, personal device architectures, portable personal computing devices, and/or software architectures.

For example, processor(s) may include central processing units (CPUs). CPUs may, for example, serve as the 'brain' of computer systems, such as by executing instructions and/or processing data, for example. A processor may, for example, include an arithmetic logic unit (ALU), a control unit, and/or numerous registers. Processor(s) may, for example, include graphics processing units (GPUs). GPUs may, for example, be configured to render images, videos, and/or animations. GPUs may, for example, advantageously provide greater speed for parallel processing tasks. Accordingly, GPUs may, for example, be advantageously used for tasks using intensive graphical computations.

Some embodiments may, for example, include application-specific integrated circuits (ASICs). ASICs may, for example, be custom-designed circuits (e.g., chips) tailored for specific applications. ASICs may, for example, provide high performance and/or efficiency. Some embodiments may, for example, include field-programmable gate arrays (FPGAs). FPGAs may be configured, for example, as reconfigurable chips that can be programmed to perform various functions. FPGAs may, for example, advantageously be used in prototyping and/or specialized computing tasks.

Microprocessors may, for example be configured as general-purpose chips. Microprocessors may, for example, execute instructions from software applications. As such, microprocessors may advantageously be utilized, for example, in a wide range of devices, from desktop computers to embedded systems.

Memory modules, may, for example, include volatile memory (RAM) and/or non-volatile memory (ROM). RAM may, for example, be used for temporary data storage. ROM may, for example, store firmware and/or system-level software.

Storage devices may include, for example, hard disk drives (HDDs), solid-state drives (SSDs), and/or optical drives. Storage devices may, by way of example and not limitation, store a device operating system(s), applications, and/or user data.

Input/output (I/O) interfaces may include, by way of example and not limitation, data ports, graphics ports, and/or audio ports. Data ports may include, for example, USB ports (e.g., USB-A, USB-C, USB-Mini, USB-Micro), Ethernet (e.g., RJ45), SATA ports, serial and/or parallel ports. Graphics ports may include, for example, HDMI ports, VGA ports, and/or Display Port ports. Some ports may, for example, be multi-purpose (e.g., USB-C may carry audio, graphics, and/or other data). Audio ports may include, for example, audio jacks. I/O interfaces may, for example, facilitate communication between the computer and peripheral devices.

Display technologies may include, by way of example and not limitation, liquid crystal displays (LCDs). LCDs may, for example, be used in monitors, laptops, and/or televisions. LCDs may, for example, modulate light passing through liquid crystals to produce images. Display technologies may include, for example, light emitting diode (LED) displays. LED displays may, for example, utilize an array of LEDs for back lighting and/or as a primary display technology. LED displays may, for example, offer enhanced brightness and/or color accuracy (e.g., compared to LCDs). Organic light emitting diode (OLED) displays, for example, may employ organic compounds that emit light when an electric current is applied. OLED displays may, for example, advantageously provide high contrast ratios and/or fast response times. Dsiplay technologies may, for example, include electronic paper displays (EPDs), which may also be known as e-ink displays. EPDs may, for example be employed in e-readers. EPDs may, for example, deliver a paper-like reading experience, reduce eye strain, and/or reduce power consumption.

Interface technologies may, for example, encompass various devices that enable user interaction with a computer system. Some embodiments may, for example, include a mouse(s). A mouse may, for example, be configured as a pointing device that detects motion and translates it into cursor movement on the screen. As such, a mouse may, for example, advantageously allow a user to interact with graphical user interfaces.

Keyboards may, for example, be configured for text entry and/or command execution. A keyboard may, for example, include multiple keys (e.g., arranged in a standard layout).

Touch inputs may, for example, enable direct interaction with a display or other input device through gestures such as tapping, swiping, and/or pinching.

Some embodiments may, for example, include an audio capture device(s), such as a microphone(s). for example, a device may be configured to record voice inputs. Some embodiments may, for example, leverage voice recognition technology, allowing users to control devices and/or enter text using spoken commands.

Additional interface technologies which may be included in some embodiments may, by way of example and not limitation, include track pads, joysticks, styluses, and/or game controllers.

Various embodiments may include one or more power supply and/or storage technologies. For example, power supplies may convert electrical power from an outlet into usable power for a device's components. A power supply may, for example, include one or more transformers, rectifiers, and/or regulators. Batteries may, for example, advantageously provide portable power for devices such as laptops, smartphones, and/or tablets. Batteries of one or more chemistries may be used, including, by way of example and not limitation, lithium-ion and/or nickel-metal hydride.

In some embodiments, devices disclosed herein may be configured as and/or connected in a server architecture. A server architecture may, for example, be configured to advantageously provide scalable computing resources, such as in enterprise environments, for example. Some embodiments may, for example, include blade servers. Blade servers may, for example, be configured as modular servers that fit into a chassis, which may advantageously allow for high-density computing and/or optimize space and/or power efficiency in data centers. Rack servers may, for example, be configured to be mounted in standardized racks. Rack servers may, for example, advantageously provide scalable computing resources. Cloud servers may, for example, include virtualized servers, which may be hosted in data centers. Cloud servers may, for example, advantageously offer flexible and/or scalable resources to users over the internet.

In some embodiments, devices disclosed herein may be configured as and/or connected to a personal device architecture, for example. Personal device architectures may include, for example, desktop computers. A desktop computer may, for example, include a tower, monitor, keyboard, and mouse, and may be used, for example, for a wide range of applications, from office work to gaming. Laptops may, for example, be configured as portable computers. The portable computers may, for example, integrate a display, keyboard, and position input (e.g., track pad) into a single unit. Laptops may, for example, be used for mobile computing and may, for example perform many of the same tasks as desktops. Portable personal computing devices may, by way of example and not limitation, include smartphones. Smartphones may be configured, for example, as compact devices that combine computing capabilities with telecommunication functions. These devices may include, by way of example and not limitation, touchscreens, cameras, and/or various sensors. Portable personal computing devices may include, for example, smartwatches. Smartwatches may, for example, be configured as wearable devices. Smartwatches may, for example, provide notifications, fitness tracking, and/or other functionalities. Smartwatches may, for example, be configured to pair with smartphones and/or other computer(s) for extended capabilities. Portable personal computing devices may, for example, include tablets. Tablets may, for example, be configured as portable devices with touchscreens larger than smartphones. Tablets may, for example, advantageously be used for tasks such as web browsing, media consumption, and/or productivity applications.

Engines and/or modules disclosed herein may be configured in one or more software architectures. Software architectures may, for example, include operating systems. Operating systems may, for example, manage hardware resources and/or provide a platform for running applications.

Software architectures may, for example, include application software. Application software may include, for example, programs designed for specific tasks.

Software architectures may, for example, include middleware. Middleware may, for example, be configured to provide services to software applications beyond those offered by the operating system. Middleware may, for example, include components such as web servers, database management systems, and/or message brokers.

Software architectures may include, for example, firmware. Firmware may, for example, be configured as low-level software embedded in hardware devices. Firmware may, for example, controls functions of the hardware devices. Firmware may, by way of example and not limitation, be stored in ROM and/or flash memory.

Software architectures may, for example, include virtualization technology. Virtualization technology may, for example, be configured to allow multiple virtual machines to run on a single physical machine. Virtualization technology may, for example, advantageously enable efficient resource utilization and/or isolation.

Various embodiments may, for example, include connection and/or communication technologies. Such technologies may, by way of example and not limitation, be configured to facilitate the exchange of data across various distances and/or environments. Long-range communication technologies may, by way of example and not limitation, include cellular networks, satellite communications, and/or broadband internet connections. Cellular networks, such as 4G LTE and 5G, may advantageously provide wireless connectivity over large areas. Cellular networks may, for example, enable devices (e.g., mobile devices) to access the internet, make calls, and/or otherwise transmit data. Satellite communications may, for example, advantageously provide global coverage, which may be particularly useful in remote and/or underserved regions where terrestrial infrastructure is limited. Broadband internet connections may include, by way of example and not limitation, fiber-optic, DSL, and/or cable. Broadband may, for example, advantageously provide high-speed internet access to devices such as for activities including streaming, online gaming, and/or remote work.

Local communication technologies may, for example, encompass methods for connecting devices within a limited area, such as a home, office, and/or campus. Local communication technologies include, for example, Wi-Fi. Wi-Fi may, for example, connect device(s) to a wireless local area network (WLAN) and/or access the internet and/or share resources (e.g., printers, storage). Wired communication technology, such as Ethernet, may, for example, advantageously provide reliable and/or high-speed connections between devices in a local network, such as, by way of example and not limitation, desktops, servers, and/or network switches. Power-line communication (PLC) may, for example, enable data transmission over existing electrical wiring. PLC may, for example, advantageously provide an option for connecting devices in locations where Wi-Fi signals may be weak or unreliable.Near field communication (NFC) and BLUETOOTH are examples of short-range communication technologies. Short-range communication technologies may, by way of example and not limitation, be configured to connect devices within a few centimeters to several meters. NFC may, for example, include wireless technology configured to enable contactless communication between devices. NFC may, for example, be configured for use with mobile payments, access control, and/or data transfer. Its short range may, for example, advantageously enhance security by necessitating close proximity for communication. Bluetooth may, for example, provide wireless connectivity over a range of meters (e.g., up to 100 meters). Bluetooth may, for example, advantageously be deployed in implementations connecting peripherals such as keyboards, mice, headphones, and/or wearable devices, and/or for transferring files between devices.

It will be understood that various modifications can be made within the scope of this disclosure. For example, one or more advantageously results may be achieved if components are removed, added, multiplied, scaled, and/or rearranged, and/or if steps in a method are omitted, added, repeated, and/or performed in a different order. Therefore, other implementations are contemplated within the scope of the following claims.

1. An apparatus, comprising:
an interactive toy that displays a dynamic indication to a child in response to a child initiating interaction with the interactive toy;
a communication module operably coupled to the interactive toy and configured to receive a responsive interaction index (RII) package from a separate device, wherein the RII package comprises an aggregated index derived from a plurality of time-distributed parent-provided behavioral indicators regarding the child, wherein at least some of the plurality of time-distributed parent-provided behavioral indicators are provided at times when the child is not interacting with the interactive toy; and
a response generation engine operably coupled to the communication module and configured to select, based on the aggregated index, the dynamic indication from a plurality of predetermined indications, such that the dynamic indication displays a single present representation of the time- distributed parent-provided behavioral indicators.

2. The apparatus of claim 1, wherein the dynamic indication comprises a visual display.

3. The apparatus of claim 2, wherein the visual display comprises an LED array, a snow globe display, or some combination thereof.

4. The apparatus of claim 1, wherein the aggregated index is derived by computing a weighted average of the plurality of time-distributed parent-provided behavioral indicators.

5. The apparatus of claim 1, wherein the response generation engine is configured to select the dynamic indication by comparing a value of the aggregated index to a plurality of threshold values, each threshold value corresponding to one of the plurality of predetermined indications.

6. The apparatus of claim 1, wherein the RII package comprises a numerical index value and a timestamp indicating when the aggregated index was computed.

7. The apparatus of claim 1, wherein the RII package is generated by an index generation engine hosted on a cloud computing network.

8. The apparatus of claim 1, wherein the interactive toy comprises an educational toy.

9. The apparatus of claim 1, wherein the time-distributed parent-provided behavioral indicators are provided by a biological parent, a caregiver, a sibling of the child, a teacher, or some combination thereof.

10. The apparatus of claim 1, further comprising one or more sensors operably coupled to the response generation engine and configured to detect the child initiating interaction with the interactive toy.

11. The apparatus of claim 10, wherein the one or more sensors comprise a motion sensor, a touch sensor, a proximity sensor, or some combination thereof.

12. The apparatus of claim 10, wherein the response generation engine is configured to select the dynamic indication based on detected child interactions and the aggregated index.

13. The apparatus of claim 1, wherein the separate device comprises a smartphone, a tablet computer, a desktop computer, a smart television, a dedicated remote control device, or some combination thereof.

14. The apparatus of claim 1, wherein the communication module is configured to wirelessly receive the RII package via Bluetooth communication, Wi-Fi communication, or some combination thereof.

15. The apparatus of claim 1, wherein the time-distributed parent-provided behavioral indicators comprise numerical ratings, categorical assessments, free-form text descriptions, voice recordings, or some combination thereof.

16. A method, comprising:
receiving, by a communication module operably coupled to an interactive toy, a responsive interaction index (RII) package from a separate device, wherein the RII package comprises an aggregated index derived from a plurality of time-distributed parent-provided behavioral indicators regarding a child, wherein at least some of the plurality of time-distributed parent-provided behavioral indicators are provided at times when the child is not interacting with the interactive toy;
detecting, by the interactive toy, the child initiating interaction with the interactive toy;
selecting, by a response generation engine operably coupled to the communication module and based on the aggregated index, a dynamic indication from a plurality of predetermined indications, such that the dynamic indication displays a single present representation of the time- distributed parent-provided behavioral indicators; and
displaying, by the interactive toy, the dynamic indication to the child in response to the child initiating interaction with the interactive toy.

17. The method of claim 16, wherein the aggregated index is derived by computing a weighted average of the plurality of time-distributed parent-provided behavioral indicators.

18. The method of claim 16, wherein selecting the dynamic indication comprises comparing a value of the aggregated index to a plurality of threshold values, each threshold value corresponding to one of the plurality of predetermined indications.

19. The method of claim 16, wherein the RII package comprises a numerical index value and a timestamp indicating when the aggregated index was computed.

20. The method of claim 16, wherein the RII package is generated by an index generation engine hosted on a cloud computing network.
